(19) United States
(12) Patent Application Publication
(10) Pub. No.: US 2007/0138086 A1
(43) Pub. Date: Jun. 21, 2007

(54) Scraper

(76) Inventor: Pekka Tuomikoski, Rauma (JP)

Correspondence Address: Woodling Krost and Rust, 9213 Chillicothe Road, Kirtland, OH, 44094, US

(21) Appl. No.: 10/588,522

(22) PCT Filed: Jan. 7, 2005
(86) PCT No.: PCT/FI05/00009

§ 371 Date: Aug. 7, 2006

(30) Foreign Application Priority Data
Feb. 17, 2004 (FI) 20040247

(51) Int. Cl. B01D 21/18; B01D 21/06; F16G 13/10; B65G 19/20

(52) U.S. Cl. 210/526; 210/407

(57) ABSTRACT

The invention relates to a scraper, which comprises an elongated, at least tension transmitting flexible structure, which is formed of formed pieces (X), being coupled with each other one after the other in a longitudinal direction (s) and that are arranged to twist (w1) in respect with each other round an axis standing in a direction of height (h) by means of a joint arrangement (N), whereby the joint arrangement (N) comprises edge projections (N1), existing in a preceding formed piece one below the other in the direction of height (h) of the formed piece, and a cental projection (N2) existing in the following formed piece and that is to be placed between the above edge projections. A joint arrangement (N; N′) is arranged to enable twisting (w2) of the successive formed pieces (X) in respect with each other round an essentially longitudinal axis (s).

The invention relates to a scraper, which comprises an elongated, at least tension transmitting flexible structure, which is formed of formed pieces, being coupled with each other one after the other in a longitudinal direction and that are arranged to twist in respect with each other round an axis standing in a direction of height by means of a joint arrangement, whereby the joint arrangement comprises edge projections, existing in a preceding formed piece one below the other in the direction of height of the formed piece, and a centre projection, existing in the following formed piece and that is to be placed between the above edge projections.

In Finnish patent No. 106947 there has been presented a scraper bar apparatus, which is meant to be used for scraping of substance in a liquid basin e.g. to a surface or a bottom chute by means of a scraper bar arrangement moving in the liquid basin. The scraper bar apparatus comprises thus an endless power transmission arrangement surrounding an area of the fluid basin to be treated, which is e.g. chain, wire rope or rope structured and arranged during an operational situation to circulate along the periphery of the treatment area by means of control and drive means. One or more scraper bars have been attached to the power transmission arrangement by their opposite ends, which, while rotating in the fluid basin, perform scraping of the fluid basin essentially all over the desired treatment area. This kind of a solution enables use of a flexible scraper bar, being attached by its opposite ends e.g. to a driving chain in a way that it is able to rotate continuously in the fluid basin inspite of the change distance between its opposite fastening ends, while simultaneously eliminating possible manufacturing/installation inaccuracies of the fluid basin and/or the power transmission arrangement.

In said patent it is suggested to use a flexible structure as the scraper bar, such as a continuous wire rope, rope, hose, fabric, plastic, bar structure or some kind of a combination formed of the above. In the patent in question there has been suggested on the other hand use of a scraper bar, also, which consists of formed pieces, which are coupled with each other in a twisting manner by joints or correspondingly.

In tests in practice it has been found that the type of first mentioned, so called rope-like scraper bar is not adequately “erect” as such in this type of applications, which is why its operating position does not stay as desired in prolonged use. On the other hand, when using fabric materials or other similar texture structures, a problem is caused due to infavourable material getting collected to the same. On the other hand for the part of the scraper bar mentioned in the patent in question, there has been found also a need for development particularly due to the fact that a type of so called chain-structured scraper bar, being suggested therein, is rather stiff, which is why the scraper bar tends to twist as a whole, when the scraper wipes e.g. over an exhaust chute. This is why the functioning of the type of scraper structure in question is not satisfactory, because the scraper bar while getting twisted simultaneously rises upwards, whereby substance to be scraped may pass under the scraper.

It is an aim of the scraper according to the present invention to achieve a decisive improvement in the problems described above and thus to raise essentially the prior art in the field. In order to achieve this aim, the scraper according to the invention is primarily characterized in that the joint arrangement, coupling the formed pieces, is arranged to enable twisting of the successive formed pieces in respect with each other round an essentially longitudinal axis.

By means of a scraper according to the invention it is possible to carry out with very simple structures an extremely reliably functioning scraper, which operates in a desired manner also in connection with floating structures. The optimum scraper movements of the scraper are made possibled by enabling the successive formed pieces to twist in respect with each other when needed round an essentially longitudinal axis of rotation, which is why the scraper maintains a continuous contact e.g. to the counterpart surface of an exhaust chute and on the other hand also an optimum scraping position for the part of the contactless formed pieces. As an advantageous embodiment the scraper is furthermore arranged to be put together from parts e.g. in a way that a skirt part, which wears along with scraping, can be changed during maintenance measures. As an advantageous embodiment of the scraper according to the invention, there is arranged furthermore an auxiliary weight arrangement in its lower part when necessary in order to keep the scraper in a vertical position, when it goes freely on the surface of the fluid basin. Thanks to a stiffening/sealing arrangement, belonging as an advantageous embodiment to the scraper according to the invention, it is possible to affect functioning of the scraper both for the part of the scraping and so that substance to be scraped may not pass in an unwanted manner between the successive formed pieces or upwards along the same.

Advantageous embodiments of the scraper according to the invention have been presented in the dependent claims related to the same.

In the following description, the invention is being described in detail with reference to the attached drawings, whereby in

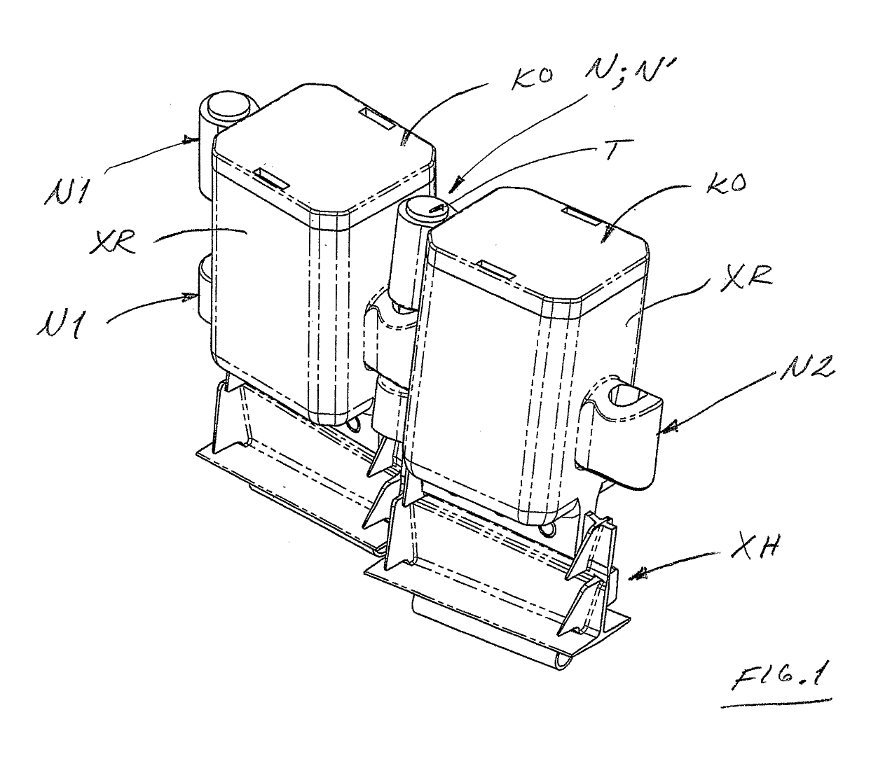

FIG. 1 is shown as a perspective view two advantageous formed pieces belonging to the scraper according to the invention, being coupled with each other,

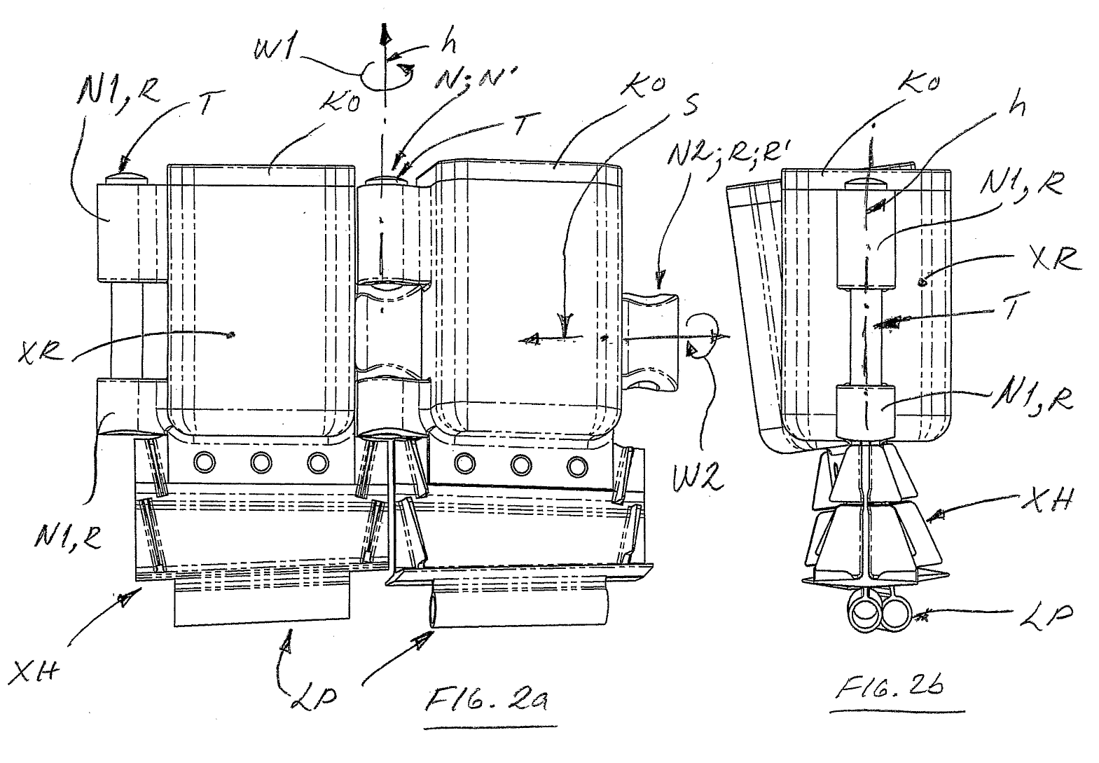

FIGS. 2a and 2b is shown successively coupled formed pieces, as shown in FIG. 1, as a side view and as a front view,

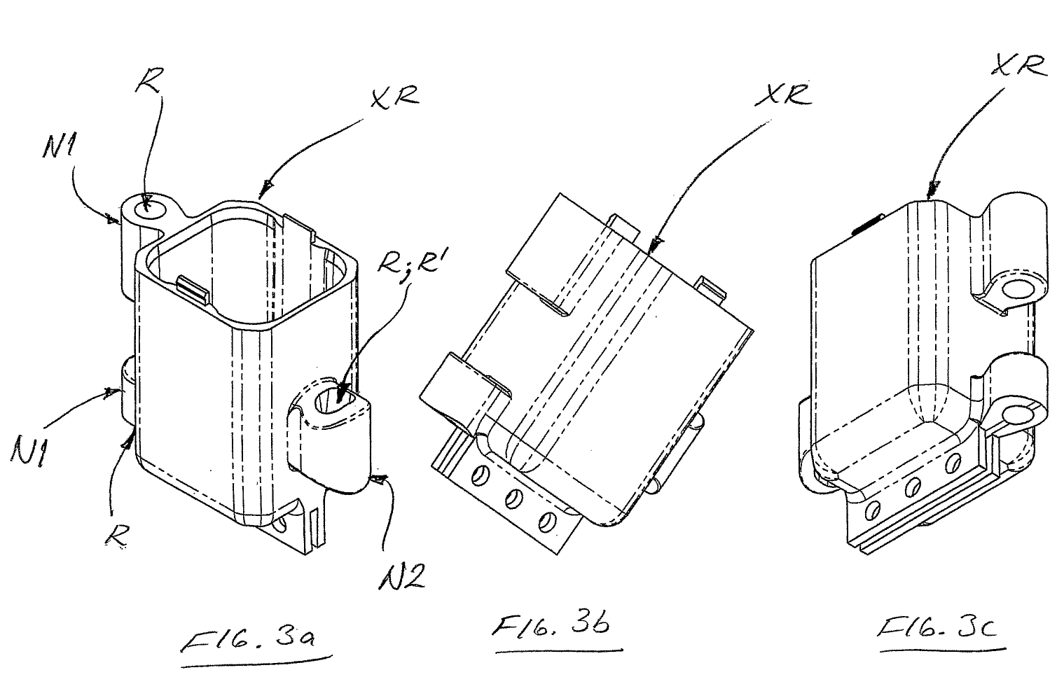

FIGS. 3a, 3b, 3c is shown an advantageous frame of a formed piece belonging to the scraper according to the invention as perspective views seen from different directions,

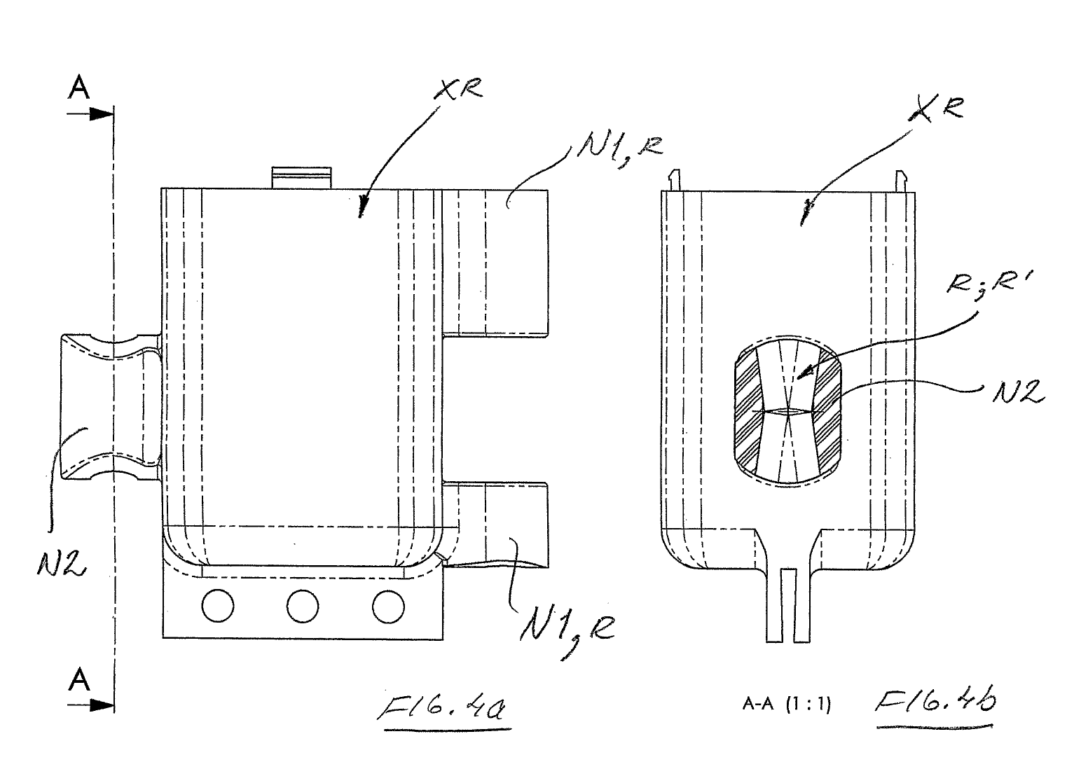

FIGS. 4a and 4b is shown the frame of the formed piece, shown in FIGS. 3a-3c, as a side view and as a front view,

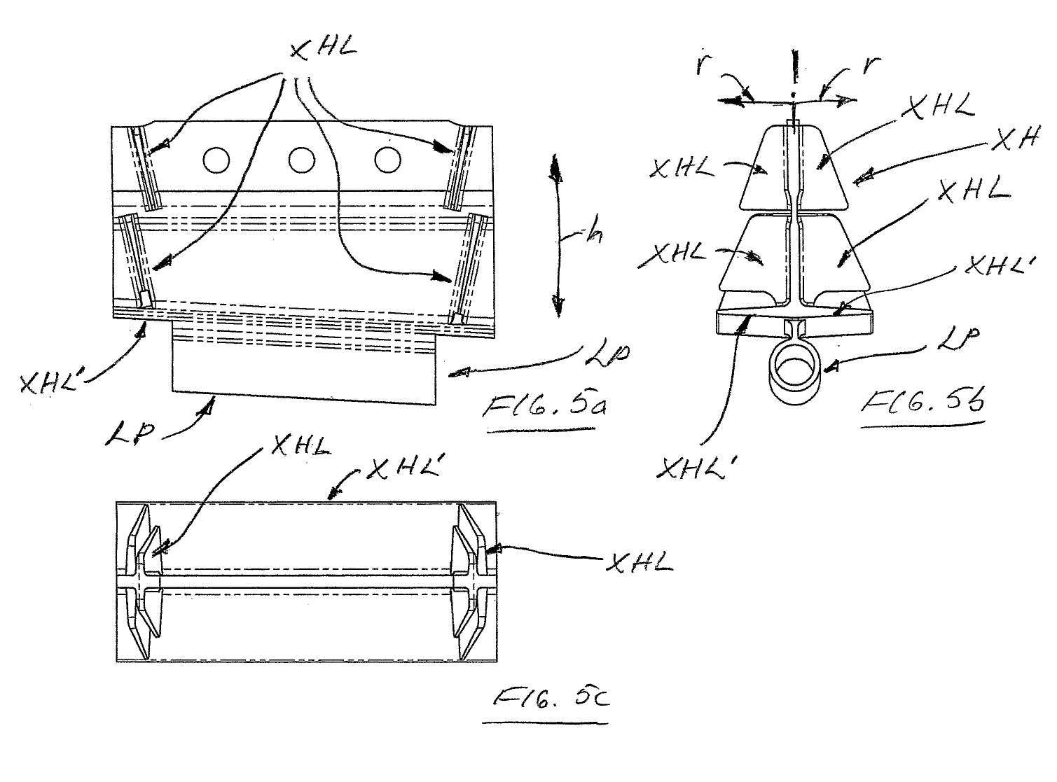

FIGS. 5a-5c is shown an advantageous skirt part of a formed piece, belonging to a scraper according to the invention, as a side view, as a front view and as a view seen from below,

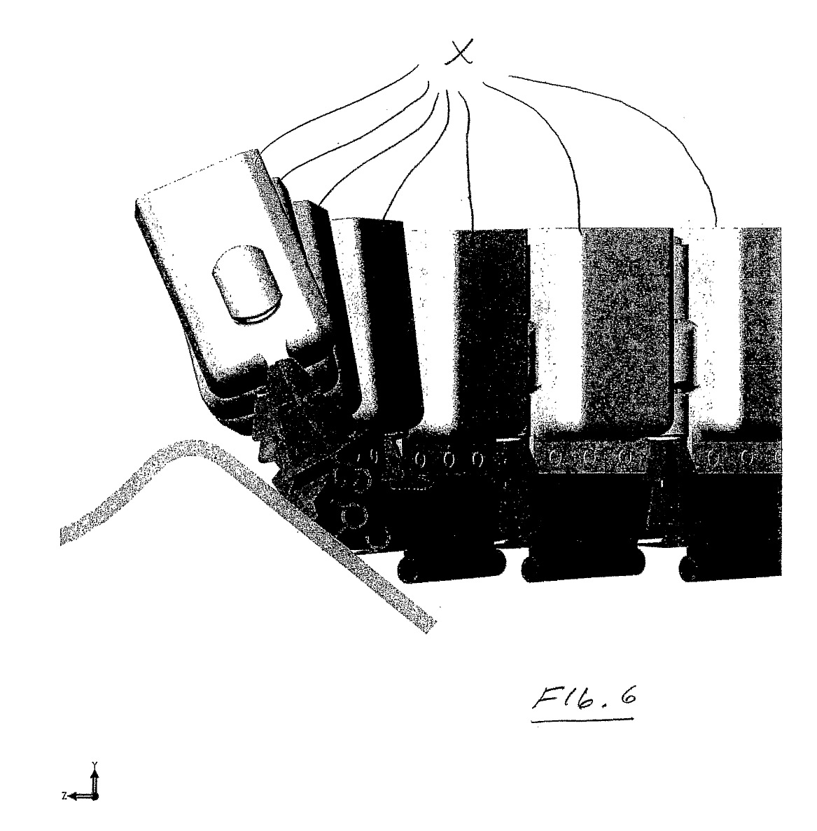

FIG. 6 is shown as a perspective view functioning of a scraper according to the invention, when it hits an exhaust chute,

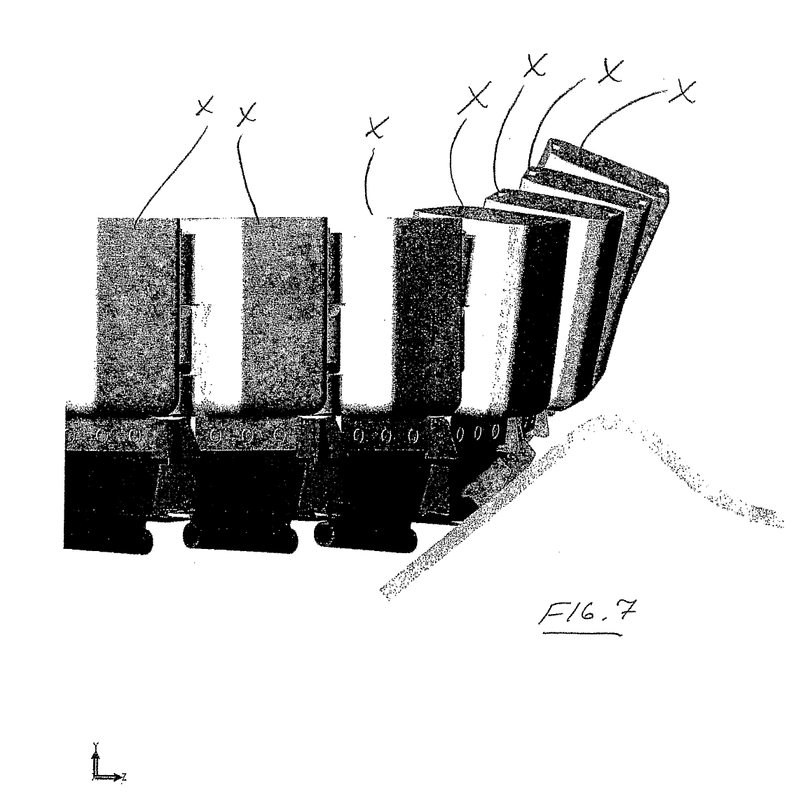

FIG. 7 is shown the situation, shown in FIG. 6, as seen from the opposite direction, and

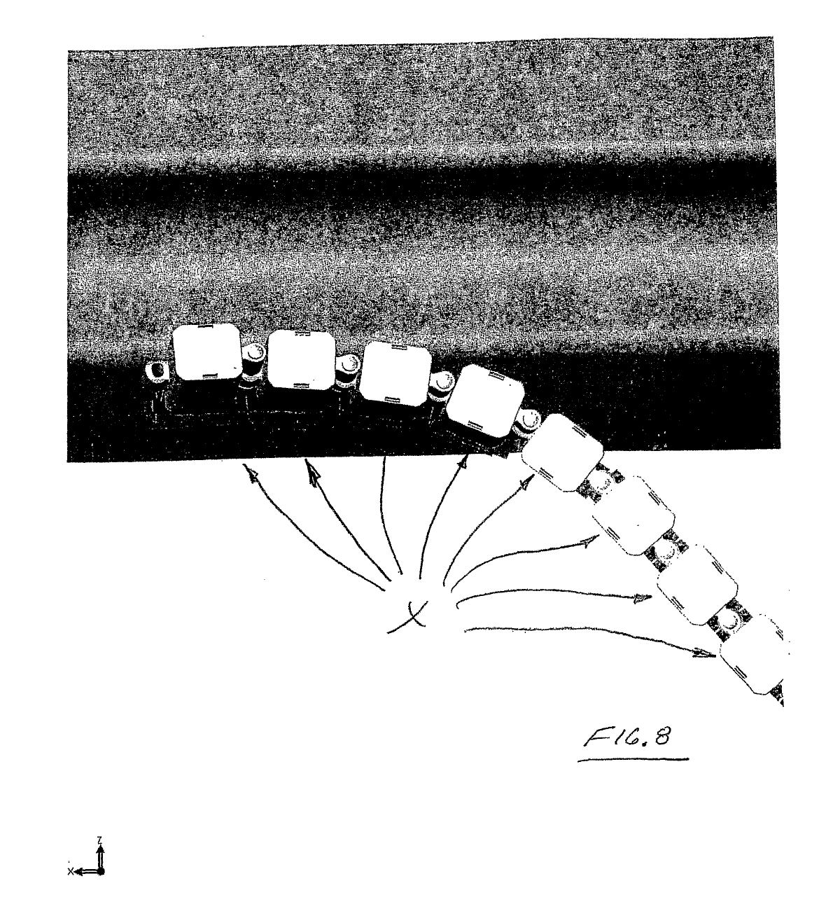

FIG. 8 is shown the situation according to FIGS. 6 and 7 as seen from above.

The invention relates to a scraper, which comprises an elongated, at least tension transmitting flexible structure, which is formed of formed pieces X, being coupled with each other one after the other in a longitudinal direction s and that are arranged to twist w1 in respect with each other round an axis standing in a direction of height h by means of a joint arrangement N, whereby the joint arrangement N comprises edge projections N1, existing in a preceding formed piece one below the other in the direction of height h of the formed piece, and a centre projection N2, existing in the following formed piece and that is to be placed between the above edge projections. A joint arrangement N; N′ is arranged to enable twisting w2 of the successive formed pieces X in respect with each other round an essentially longitudinal axis s, which principle may be seen particularly from FIGS. 2a, 2b, 6, 7 and 8.

The joint arrangement N comprises as an advantageous embodiment a hole R for a joint pin T or a like in said projections N1, N2, the hole existing essentially in the direction of height h. The upper and lower edges of the centre projection N2 are arranged, e.g. as shown in FIGS. 1, 2a, 3a-3c, arched and the hole therein R; R′ to expand, when viewed in a cross section e.g. as shown in FIG. 4b, from the centre projection's N2 middle towards its upper and lower edges, which makes possible swinging of the formed piece in respect with the joint pin T.

As an advantagoeus embodiment, each formed piece X of the scraper is mutually alike in a way that on its first joint surface there are edge projections N1 and on the other joint surface there exists the centre projection N2.

As an alternative solution with respect to the above there are two kinds of formed pieces in a way that on the opposite joint surfaces of the first ones of them there exists edge projections N1 and on the corresponding joint surfaces of the second ones of them there exists centre projections n2.

Furthermore as an advantageous embodiment with reference to FIGS. 2a, 2b, 3a-3c, 4a and 4b, in an essentially stiff-structured frame XR of the formed piece X there is arranged, preferably on quick-release principle, such as by a mortise and tenon joint, a removeably attachable skirt part XH, as shown e.g. in FIGS. 5a-5c, which is manufactured from essentially softer/more flexible material than the frame XR of the formed piece. In this case the frame XR of the formed piece is manufactured profitably e.g. from polyprophylene or like and correspondingly the skirt part XH from polyurethane, rubber or like.

As an advantageous embodiment the skirt part XH has fin-like or like stiffening/sealing arrangements XHL, XHL′, projecting outwards r from its outer surface and which are arranged to enable twisting w1 of the successive formed pieces with respect to each other round a rotation axis existing essentially in the direction of height h.

As can be seen e.g. from FIGS. 2a and 2b, a bottom fin XHL′ belonging to the stiffening/sealing arrangement is arranged to rise in the direction of height h towards the other end of the formed piece X particularly to enable twisting of the successive formed pieces with respect to each other on so called lap joint-principle.

Furthermore as an advantageous embodiment, the scraper according to the invention is meant to be used particularly as a surface scraper in a fluid basin, such as a clarification basin or like. In this case the specific weight of the scraper is arranged essentially lighter than water by using e.g. as shown in FIGS. 3a-3c a formed piece X with a hollow frame XR particularly in order to enable its use filled with air or flotation material.

Furthermore as an advantageous embodiment in the lower part of the formed piece X, such as at the lower edge of the skirt part XH, there is arranged an auxiliary weight arrangement LP, such as a sleeve-like lower edge e.g. for a metal bar with a corresponding cross-section, particularly for keeping the formed piece in an essentially vertical position, when it goes freely on the fluid surface.

It is clear that the invention is not limited to the embodiments shown or described above, but it can be modified within the basic idea of the invention according to the needs and applications at any given time. Thus, a scraper according to the invention is particularly applicable also e.g. in so called oil containment boom-use or like, because with a scraper according to the invention it is possible, in addition to restricting of oil that exists on the water, also to remove it thanks to the structure of the scraper that “lives” along with the surface of the water.

Furthermore it is naturally clear that a formed piece belonging to the scraper according to the invention may be put together e.g. so that all of its subcompositions are built-in. On the other hand it is also possible to variate the shape and equipmentation of the formed pieces with respect to what has been presented before. In addition to the above, the formed piece belonging to the scraper according to the invention, as well as other subentireties belonging to the same may be manufactured by utilizing the most differing manufacturing techniques from the most deviating materials.

1. Scraper, which comprises an elongated, at least tension transmitting flexible structure, which is formed of formed pieces (X), being coupled with each other one after the other in a longitudinal direction (s) and that are arranged to twist (w1) in respect with each other round an axis standing in a direction of height (h) by means of a joint arrangement (N), whereby the joint arrangement (N) comprises edge projections (N1), existing in a preceding formed piece one below the other in the direction of height (h) of the formed piece, and a centre projection (N2), existing in the following formed piece and that is to be placed between the above edge projections, characterized in that a joint arrangement (N;N′) is arranged to enable twisting (w2) of the successive formed pieces (X) in respect with each other round an essentially longitudinal axis (s).

2. Scraper according to claim 1, the joint arrangement (N) of which comprises a hole (R) for a joint pin (T) or a like in said projections (N1, N2), the hole existing essentially in the direction of height (h), characterized in that the upper and lower edges of the centre projection (N2) are arranged arched and the hole therein (R; R′) to expand, when viewed in a cross section, from the centre projection's (N2) middle towards its upper and lower edges.

3. Scraper according to claim 1 or 2, characterized in that each formed piece (X) of the scraper is mutually alike in a way that on its first joint surface there are edge projections (N1) and on the other joint surface there exists the centre projection (N2).

4. Scraper according to claim 1 or 2, characterized in that there are two kinds of formed pieces in a way that on the opposite joint surfaces of the first ones of them there exists edge projections (N1) and on the corresponding joint surfaces of the second ones of them there exists centre projections (n2).

5. Scraper according to any of the preceding claims 1-4, characterized in that in an essentially stiff-structured frame (XR) of the formed piece (X) there is arranged, preferably on quick-release principle, a removeably attachable skirt part (XH), which is manufactured from essentially softer/more flexible material than the frame (XR) of the formed piece.

6. Scraper according to any of the preceding claims 1-5, characterized in that the frame (XR) of the formed piece is manufactured from polyprophylene or like and a skirt part (XH) from polyurethane, rubber or like.

7. Scraper according to any of the preceding claims 1-6, characterized in that the skirt part (XH) has fin-like or like stiffening/sealing arrangements (XHL, XHL′), projecting outwards (r) from its outer surface and which are arranged to enable twisting (w1) of the successive formed pieces with respect to each other round a rotation axis existing essentially in the direction of height (h).

8. Scraper according to claim 7, characterized in that a bottom fin (XHL′) belonging to the stiffening/sealing arrangement is arranged to rise in the direction of height (h) towards the other end of the formed piece (X) particularly to enable twisting of the successive formed pieces with respect to each other on so called lap joint-principle.

9. Scraper according to any of the preceding claims 1-8, which is meant to be used particularly as a surface scraper in a fluid basin, such as a clarification basin or like, characterized in that the specific weight of the scraper is arranged essentially lighter than water by using a formed piece (X) with a hollow frame (XR) particularly in order to enable its use filled with air or flotation material.

10. Scraper according to claim 9, characterized in that in the lower part of the formed piece (X), such as at the lower edge of the skirt part (XH), there is arranged an auxiliary weight arrangement (LP) particularly for keeping a floating formed piece in an essentially vertical position.
